(19) United States
(12) Patent Application Publication
(10) Pub. No.: US 2024/0380149 A1
(43) Pub. Date: Nov. 14, 2024

(54) RELIABLE, ADAPTABLE ELECTRICAL CONNECTOR WITH HIGH CURRENT CAPACITY

(71) Applicant: Amphenol Technology (Zhuhai) Co, Ltd., Zhuhai (CN)

(72) Inventors: Peng Huang, Zhuhai (CN); Jiapeng Wu, Zhuhai (CN); Ming Weng, Zhuhai (CN)

(73) Assignee: Amphenol Technology (Zhuhai) Co,Ltd., Zhuhai (CN)

(21) Appl. No.: 18/659,192

(22) Filed: May 9, 2024

(30) Foreign Application Priority Data
May 9, 2023 (CN) 202310517646.6

(51) Int. Cl. H01R 13/11; H01R 13/04

(52) U.S. Cl. CPC H01R 13/111; H01R 13/04

(57) ABSTRACT

An electrical connector with high current capacity. The connector has a sleeve and a terminal disposed therein. The terminal includes one or more conductive elements each comprising first portions with inflection points abutting the sleeve, and second portions connecting adjacent first portions. When inserting a pin into the terminal, the second portions are expanded radially by the pin. The expansion of the second portions increases contact areas and forces between the first portions and the sleeve to reliably connect the pin to the sleeve through the second portions to the first portions. The number of first portions of each conductive element can be configured to achieve desirable contact area and force. A terminal may include multiple conductive elements and the number can be selected according to a length of a pin. Techniques described herein enables reliable, adaptable connectors with high current capacity.

### RELATED APPLICATION

This application claims priority to and the benefit of Chinese Patent Application Serial No. 202310517646.6, filed on May 9, 2023, the contents of which are incorporated herein by reference in their entirety.

### TECHNICAL FIELD

This application relates generally to interconnection systems, such as those including electrical connectors, used to interconnect electronic assemblies.

### BACKGROUND

Electrical connectors implement electrical connection and signal transmission between devices, between assemblies, and between systems, and are essential elements for forming a complete system.

An existing electrical connector may have a side surface configured to receive a pin. The pin may be in contact with an inner side of a socket when the pin is inserted into the socket such that the pin is electrically connected with the socket through an elastic sheet. An example of a connector that receives a pin is shown in U.S. Pat. No. 11,929,571, the Assignee of that patent sells connectors called RADSOK connectors.

### SUMMARY

Aspects of the present disclosure relate to reliable, adaptable electrical connectors with high current capacity.

Some embodiments relate to a terminal. The terminal may comprise one or more conductive elements encircling, at least in part, an area with a center, each of the one or more conductive elements comprising: at least two first portions each offset from the center by more than a first radius; and a plurality of second portions connecting adjacent first portions of the at least two first portions and offset from the center by less than the first radius.

Optionally, each of the one or more conductive elements is configured to expand and contract in a radial direction with respect to the center of the area.

Optionally, the one or more conductive elements comprises two conductive elements stacked in an axial direction extending perpendicular to a radial direction with respect to the center of the area.

Optionally, the terminal comprises a member connecting the two conductive elements.

Optionally, the member is disposed between the two conductive elements and joins first portions of the two conductive elements.

Optionally, each of the one or more conductive elements comprises a first end and second end separated from each other.

Optionally, for each of the one or more conductive elements: the first end and second end are disposed in one of the at least two first portions.

Optionally, at least one conductive element of the one or more conductive elements comprises one or more projections extending from an edge of the at least one conductive element and disposed between respective adjacent first portions of the at least one conductive element; and the one or more projections is angled away from the center.

Optionally, each of the one or more conductive elements comprises three to six first portions.

Optionally, the one or more conductive elements is stamped from a sheet of metal.

Optionally, a thickness of the sheet defines a radial extent of each of the one or more conductive elements.

Optionally, surface of the sheet defines surfaces of the one or more conductive elements facing the area.

Optionally, each of the plurality of second portions comprises an elongated band.

Optionally, the elongated bands of the one or more conductive elements are disposed in parallel.

Optionally, each of at least two first portions comprises a bend.

Some embodiments relate to an electrical connector. The electrical connector may comprise a sleeve comprising an inner wall bounding a cavity; and terminal disposed in the cavity and comprising a conductive element, the conductive element comprising first portions abutting the inner wall of the sleeve; and second portions disposed within the cavity and connecting adjacent first portions.

Optionally, each of the first portions comprises an inflection point abutting the inner wall of the sleeve.

Optionally, the electrical connector comprises a plurality of gaps between portions of the terminal and the inner wall of the sleeve and separated from each other by the inflection points of respective first portions of the terminal abutting the inner wall of the sleeve.

Optionally, each of the plurality of gaps decreases toward the points of the respective first portions.

Optionally, each of the plurality of gaps is symmetrical.

Optionally, the plurality of gaps conforms to a wave.

Optionally, the conductive element comprises a first end and second end separate from the first end; and the first end and second end are disposed in a first portion.

Optionally, the terminal comprises a plurality of conductive elements comprising the conductive element; and the plurality of conductive elements are stacked in an axial direction extending through the cavity of the sleeve.

Optionally, the electrical connector comprises a plurality of members joining first portions of adjacent conductive elements of the plurality of conductive elements.

Optionally, the electrical connector comprises a plurality of projections extending from edges of the second portions of the plurality of conductive elements and angled away from a center of the cavity.

Some embodiments relate to a terminal mated to a pin. The terminal may comprise one or more conductive elements encircling, at least in part, the pin, each of the one or more conductive elements comprising at least two first portions and a plurality of second portions, wherein the plurality of second portions each contacts a surface of the pin at a first radius from a center of the pin; and the at least two first portions connect adjacent second portions of the plurality of second portions and offset from the center of the pin by more than the first radius.

Optionally, the one or more conductive elements is stamped from a sheet of metal.

Optionally, a thickness of the sheet defines a radial extent of each of the one or more conductive elements.

Optionally, a surface of the sheet defines surfaces of the one or more conductive elements facing the center.

Optionally, each of the plurality of second portions comprises an elongated band.

Optionally, the elongated bands of the one or more conductive elements are disposed in parallel.

Optionally, each of at least two first portions comprises a bend.

Optionally, each of the one or more conductive elements comprises one or more projections extending from edges of the second portions of the conductive element.

Some embodiments relate to a method of operating an electrical connector, the electrical connector comprising a sleeve having a cavity and a terminal disposed in the cavity and. The method may comprise inserting a pin into the terminal; expanding the terminal; and generating pressure against a circumferential surface of the pin.

Optionally, the method comprises generating pressure against an inner wall of the sleeve.

Optionally, the terminal comprises one or more conductive elements encircling, at least in part, an area with a center; and each of the one or more conductive elements comprises at least two first portions each offset from the center by more than a first radius, and a plurality of second portions connecting adjacent first portions of the at least two first portions and offset from the center by less than the first radius.

Optionally, expanding the terminal comprises expanding the at least two first portions such that contact areas between the at least two first portions and an inner wall of the sleeve increase; and expanding the plurality of second portions such that the plurality of second portions conform to the circumferential surface of the pin.

Optionally, each of the one or more conductive elements comprises a first end disposed in a first portion of the at least two first portions, and a second end disposed in the first portion of the at least two first portions and separated from the first end; and expanding the terminal comprises further increasing a distance between the first and second ends.

Optionally, each of the one or more conductive elements comprises a plurality of projections extending from edges of the plurality of second portions of the conductive element and angled away from the center; and expanding the terminal comprises for each of the one or more conductive elements, contacting the plurality of projections with the pin so as to guide the pin into contact with the plurality of second portions of the conductive element.

Some embodiments relate to a wave spring. The wave spring may comprise a plurality of spring leaves, wherein the spring leaves are annularly arranged, the spring leaves are sequentially connected and stacked in an axial direction, each of the spring leaves is provided with at least three abutting portions, the abutting portions are distributed around an outer side of a respective spring leaf, and the abutting portions are configured to expand and contract in a radial direction of the respective spring leaf.

Optionally, each of the spring leaves is provided with a first end and a second end, the first end and the second end are configured to abut against each other and to define an opening cooperatively.

Optionally, the opening is disposed in one of the at least three abutting portions.

Optionally, adjacent spring leaves of the plurality of spring leaves are connected through a connecting sheet.

Optionally, each of the plurality of spring leaves further comprises a plurality of connecting portions, two ends of each of the connecting portions are respectively connected with adjacent abutting portions of the at least three abutting portions, the connecting sheet is located on one side of a respective abutting portion or one side of the respective connecting portion, and the connecting sheet is configured for connecting the abutting portions of two adjacent spring leaves.

Optionally, one side of each of the plurality of spring leaves is further provided with a guide portion, and the guide portion is located between adjacent abutting portions of the at least three abutting portions.

Optionally, the at least three abutting portions comprises three to six abutting portions.

Some embodiments relate to a plug terminal connector. The plug terminal connector may comprise the wave spring described herein. The plug terminal connector may further comprise a sleeve, wherein an annular accommodating cavity is arranged in the sleeve, the wave spring is arranged in the accommodating cavity, and the abutting portions abut against a cavity wall of the accommodating cavity; and a contact pin, wherein the contact pin is pluggable into the wave spring.

Optionally, a plugging end of the contact pin is provided with an arc surface, and the arc surface is attachable to a guide portion of the wave spring.

Optionally, two ends of the wave spring in the axial direction respectively abut against two ends of the accommodating cavity.

Some embodiments relate to a terminal comprising one or more conductive elements, each of the one or more conductive elements comprising a plurality of first portions each having an outermost point disposed on a first annular shape; and a plurality of second portions disposed between adjacent first portions of the plurality of first portions and having end points joining respective first portions, the end portions of the plurality of second portions are disposed on a second annular shape.

Optionally, the first annular shape and second annular shape are concentric.

Optionally, portions of each of the one or more conductive elements between adjacent outermost points of the plurality of first portions each is separated from the first annular shape by a gap; and the gap decreases toward respective outermost points.

Optionally, the gap is symmetrical.

Optionally, each of the plurality of first portions is separated from the second annular shape by a first gap; and each of the plurality of second portions is separated from the second annular shape by a second gap different from the first gap.

Optionally, each of the one or more conductive elements comprises a first end disposed in a first portion; and a second end disposed in the first portion and separated from the first end.

Some embodiments relate to a terminal. The terminal may include a plurality of conductive elements. The conductive elements may be annularly shaped. The conductive elements may be sequentially connected and stacked in an axial direction. Each of the conductive elements may be provided with at least three first portions. The first portions are distributed around an outer side of a respective conductive element. The first portions can expand and contract in radial directions of the respective conductive element.

Optionally, each of the conductive elements is provided with a first end and a second end, the first end and the second end are configured to abut against each other and to define an opening cooperatively.

Optionally, the opening is disposed in one of the first portions.

Optionally, adjacent conductive elements of the plurality of conductive elements are connected through a member.

Optionally, each of the conductive elements further comprises a plurality of second portions, two ends of each of the second portions are respectively connected with adjacent first portions, the member is located on one side of the respective first portion or one side of the respective second portion, and the member is used for connecting the first portions of two adjacent conductive elements.

Optionally, one side of the conductive element is further provided with a projection, and the projection is located between two adjacent first portions.

Optionally, the first portions comprise three to six first portions.

Some embodiments relate to an electrical connector. The electrical connector may include the terminal described herein, and a sleeve comprising an annular cavity. The terminal may be arranged in the cavity of the sleeve, with the first portions abutting against a wall of the cavity.

Optionally, the terminal may be configured to receive a pin.

Optionally, an inserting end of the pin is provided with an end surface, and the end surface is attachable to the projection of the terminal.

Optionally, two ends of the terminal in the axial direction respectively abut against two ends of the cavity.

These techniques may be used alone or in any suitable combination. The foregoing summary is provided by way of illustration and is not intended to be limiting.

### BRIEF DESCRIPTION OF THE DRAWINGS

The above and/or additional aspects and advantages of the present disclosure will become apparent and easy to understand from the descriptions of embodiments with reference to the following drawings. The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electrical connector with a pin at least partially inserted therein, according to some embodiments;

FIG. 2 is a cross-sectional perspective view of the electrical connector of FIG. 1 sectioned in a vertical direction;

FIG. 3 is a perspective view of a terminal of the electrical connector of FIG. 1, showing the terminal having three first portions, according to some embodiments;

FIG. 4 is a cross-sectional view of the electrical connector of FIG. 1 sectioned in a horizontal direction through one of conductive elements (e.g., bands of compliant material) of the terminal that is above the tip of the pin, with illustrative dotted lines radially equally dividing a sleeve;

FIG. 5 is a cross-sectional view of the electrical connector of FIG. 4, showing gaps between the terminal of FIG. 3 and a circumferential surface of an outer wall of a pin as shown in FIG. 1, with portions of the illustrative dotted lines in the gaps retained for reference;

FIG. 6 is a cross-sectional view of the electrical connector of FIG. 4, with the pin hidden, showing gaps between the terminal shown in FIG. 3 and an inner wall of the sleeve of FIG. 4, with portions of the illustrative dotted lines in the gaps retained for reference;

FIG. 7 is a schematic diagram illustrating the gaps between the terminal and the circumferential surface of the outer wall of the pin shown in FIG. 5, expanded to a straight line which is equally sectioned into the same equally sectioned line segments shown in FIG. 5;

FIG. 8 is a schematic diagram illustrating the gaps between the terminal and the inner wall of the sleeve shown in FIG. 6, expanded to a straight line which is equally sectioned into the same equally sectioned line segments shown in FIG. 6;

FIG. 9 is a perspective view of a terminal, showing the terminal having four first portions, according to some embodiments;

FIG. 10 is a schematic diagram of gaps between the terminal of FIG. 9 and a circumferential surface of an outer wall of a pin, expanded to a straight line;

FIG. 11 is a schematic diagram of a gap between the terminal of FIG. 9 and an inner wall of a sleeve, expanded to a straight line;

FIG. 12 is a perspective view of a terminal, showing the terminal having five first portions, according to some embodiments; and

FIG. 13 is a perspective view of a terminal, showing the terminal having six first portions, according to some embodiments.

### REFERENCE NUMERALS

10 may refer to a terminal; 11 may refer to a conductive element; 111 may refer to a first portion; 112 may refer to a first end; 113 may refer to a second end; 114 may refer to an opening; 12 may refer to a member; 13 may refer to a projection; and 14 may refer to a second portion;
20 may refer to a sleeve; 21 may refer to a cavity; and 211 may refer to a wall;
30 may refer to a pin; 31 may refer to an end surface; and 311 may refer to a surface.

### DETAILED DESCRIPTION

The inventors have recognized and appreciated connector design techniques for making reliable, adaptable electrical connector with high current capacity. Such connectors may have lower insertion and removal forces than existing connectors of similar current carrying capacity. Alternatively or additionally, these techniques may enable connectors that engage a pin over a shorter length than existing connectors and may occupy less volume. Connectors made according to techniques described herein can be configured to achieve desirable contact area and force while adapting to a length of a mating pin, which may simplify design and operation of compact electronic systems, while supply the same or greater current.

An electrical connector with high current capacity may have a sleeve and a terminal disposed therein. The terminal may include one or more conductive elements. Each conductive element may include first portions with bends, and second portions having bands connecting adjacent first portions. In some embodiments, the first portions may include outermost points abutting the sleeve. In some embodiments, the terminal may be movable in the sleeve so as to compensate for any misalignment between the sleeve and a mating pin.

When inserting a pin into the terminal, the second portions may be expanded radially by the pin. The expansion of the second portions may increase contact areas and forces between the first portions and the sleeve so as to reliably connect the pin to the sleeve through the second portions to the first portions. Each conductive elements may have first and second ends disposed in a first portion and separated from each other. Expanding a terminal may include enlarging a distance between the first and second ends. The number of first portions of each conductive element can be configured to achieve desirable contact area and contact force. A terminal may include multiple conductive elements and the number can be selected according to a length of a pin.

In some embodiments, first portions of a terminal may be configured to expand and contract in the radial directions of the terminal so as to stably abut against an inner wall of a sleeve. When inserting a pin into the terminal, the pin may stretch the terminal such that the first portions of the terminal may extend outwardly in the radial directions to electrically connect the pin with the sleeve through the terminal. For example, the first portions of the terminal may stably abut against the inner wall of the sleeve. The number of first portions may be configurable according to desired force for a mating pin.

A terminal may include a plurality of conductive elements, each of which may include a plurality of first portions. The conductive elements may be stacked in an axial direction. The number of stacked conductive elements may be configured according to a length of a mating pin, enabling the terminal to occupy a relatively small volume. Such a configuration may simultaneously enable stable interconnection and easy mating/unmating. Furthermore, because of the small and simple structure of the terminal, the electrical connector is low in manufacturing cost and beneficial for product production.

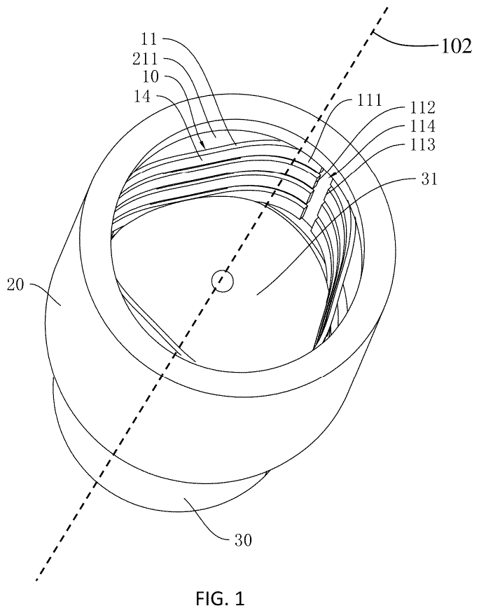

Referring to FIG. 1 to FIG. 3, as illustrated, an electrical connector may include a terminal 10 disposed in a sleeve 20. The electrical connector may mate with a pin 30. A person of ordinary skill in the art would understand that the terminal is connected to a portion of an electronic system, which is not shown for simplicity of illustration.

In the illustrated example, the terminal 10 comprises four conductive elements 11. Each of the conductive elements 11 is annularly shaped. The conductive elements 11 are sequentially connected and stacked in an axial direction 102. Each of the conductive elements 11 is provided with three first portions 111 distributed around an outer side of the conductive element 11, and second portions 14 connecting adjacent first portions 111.

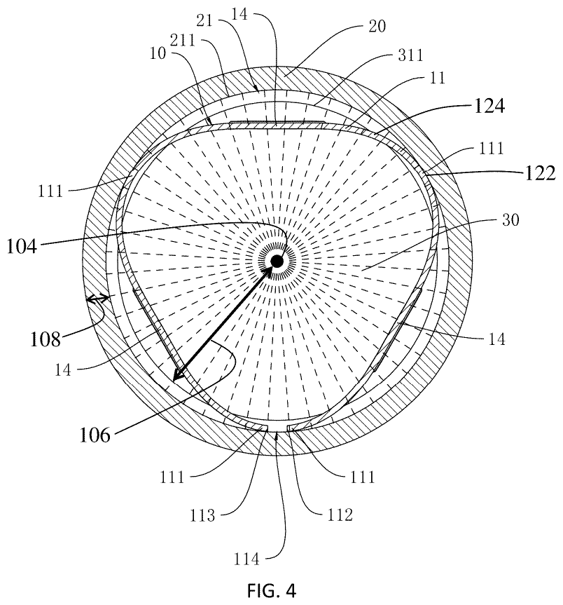

The first portions 111 may be configured to expand and contract in radial directions of the conductive element 11. As illustrated, the sleeve 20 includes an annular-shaped cavity 21. The terminal 10 is arranged in the cavity 21, with the first portions 111 abutting against a wall 211 of the cavity 21. As shown in FIG. 4, at least outermost points of the first portions 11 are disposed on an annular shape of the cavity 21.

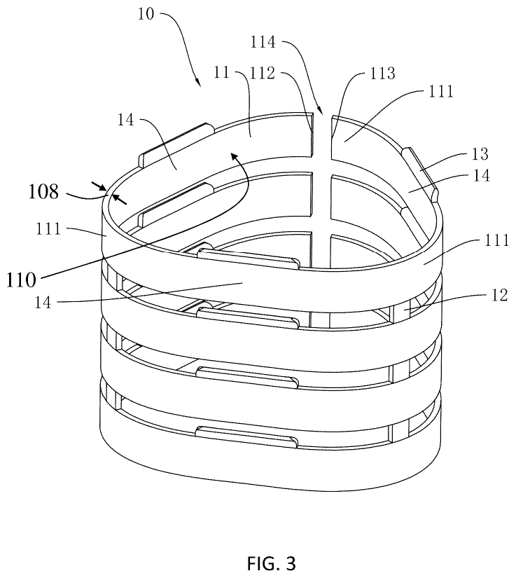

FIG. 3 illustrates the terminal 10 of the electrical connector configured as a wave spring. As can be seen the wave spring has bands of compliant material (here configured as spring leaves) shaped to contact a mating component, such as a pin 30, inserted into the terminal 10, at each of multiple locations around the perimeter of the mating component.

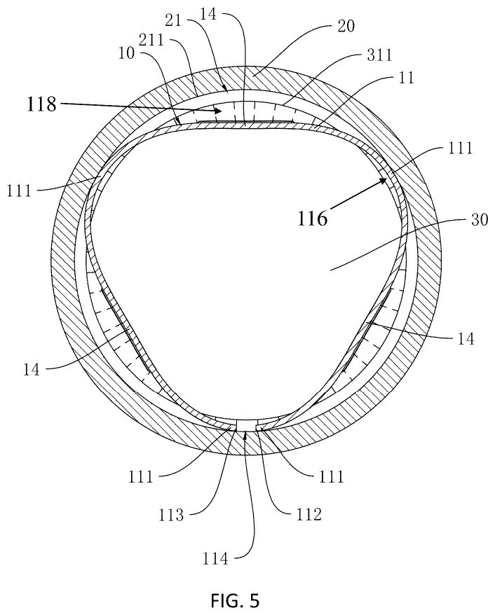

Such a terminal 10 enables the spring leaves 11 to be stamped from a sheet of metal. A thickness of the sheet may define a radial extent 108 of each spring leaf 11. A surface of the sheet may define surfaces 110 of each spring leaf facing a center 104 (FIG. 4). A pin 30 may be inserted into the terminal 10. The pin 30 may be annularly shaped. As shown in FIG. 5, the second portions 14 may have end points disposed on the annular shape of the pin 30. When inserting the pin 30 into the terminal, a surface 311 of the pin 30 can abut against inner side surfaces of the conductive element 11 of the terminal 10. The pin 30 can push the first portions 111 of the terminal 10 to extend outwardly in the radial directions of the conductive element 11 and abut against the wall 211 of the cavity 21 of the sleeve 20, thereby forming the connection between the pin 30, the terminal 10 and the sleeve 20.

By the extension and retraction of the first portions 111 in the radial directions of the conductive element 11, the first portions 111 can stably abut against an inner wall of the sleeve 20 when extending outwardly. When the pin 30 is inserted into the terminal 10, the pin 30 stretches the conductive element 11, and the first portions 111 extend outwardly in the radial directions of the conductive element 11 to stably abut against the inner wall of the sleeve 20, thereby forming the connection with the sleeve 20 through the terminal 10.

The terminal 10 has a small volume, which may be set according to a length of the pin 30. As illustrated, a plurality of conductive elements 11 are sequentially connected in an axial direction according to the length of the pin 30. The terminal 10 therefore has strong applicability. For example, although in the example illustrated in FIGS. 1-3 the terminal 10 has four conductive elements 11 connected in the axial direction 102, it should be appreciated that the number of conductive elements 11 can change (more or fewer) according to a length of a pin that the terminal 10 is configured to mate with.

An elastic force applied by the terminal 10 to the sleeve 20 may be controlled by the number of connected conductive elements 11. The number of connected conductive elements 11 may be selected to provide enough force for a secure connection yet avoid an excessively large force which can make it difficult for removing and inserting the pin 30. For example, more than three first portions 111 can be provided, such that there are more connection points between the terminal 10 and the inner wall of the sleeve 20, which can ensure a stable current overload capacity, so that the terminal has better practicability.

With reference to FIG. 1, FIG. 3 and FIG. 4, in some embodiments of the present disclosure, each of the conductive elements 11 is provided with a first end 112 and a second end 113. The first end 112 and the second end 113 may be adjacent each other. The first end 112 and the second end 113 may cooperate to define an opening 114. For example, as shown in FIG. 4 to FIG. 6, the opening 114 may be located in one of the first portions 111.

FIG. 4 is a cross-sectional view of the electrical connector in a horizontal direction. As shown in the figure, the opening 114 is located in one of the first portions 111. When the pin 30 is inserted, the conductive element 11 extends outwardly in radial directions, enlarging the opening 114 to separate the first end 112 and the second end 113 farther away from each other. The surface 311 of the pin 30 may abut against the inner side surface of the conductive element 11. With the stretching of the conductive element 11, both sides of each of the first portions 111 exert an outward pressure on the respective first portion 111. As a result, the first portion 111 exerts a larger force against the inner wall of the sleeve 20, so that the connection is more stable. Alternatively or additionally, each of the first portions 111 may be set as a smooth spherical surface to be in contact with the wall 211.

As can be seen from FIG. 4, the terminal 10 may include one or more conductive elements 11 encircling, at least in part, an area with the center 104. Each conductive element 11 may include three first portions 111 each offset from the center 104 by more than a first radius 106. Each conductive element 11 may also include multiple second portions 14 connecting adjacent first portions 111 and offset from the center 104 by less than the first radius 106.

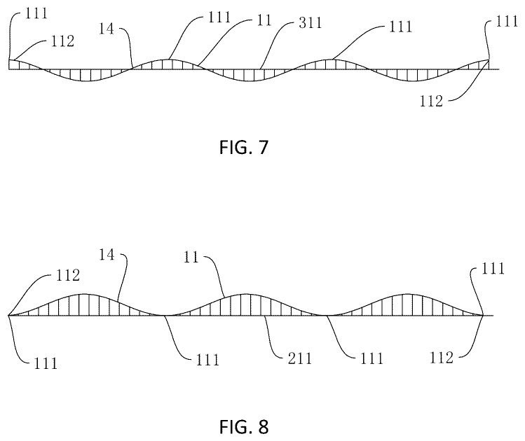

Referring to FIG. 5 and FIG. 7, FIG. 5 is a cross-sectional view of the electrical connector, showing a gap between the terminal 10 and a circumferential surface of an outer wall of the pin 30, and FIG. 7 is a schematic diagram illustrating the gap between the terminal 10 and the circumferential surface of the outer wall of the pin 30, expanded to a straight line. As shown in the figures, the straight line may have a length equal to a circumferential perimeter of the outer wall of the pin 30. As illustrated, the straight line is equally sectioned, corresponding to the line segments shown as dotted lines in FIG. 3. The line segments of the straight line and the line segments of a curve of the surface 311 of the outer wall of the pin 30 may have the same lengths.

Taking the terminal 10 provided with three first portions 111 as an example, after the terminal 10 and the surface 311 of the pin 30 are expanded along the straight line, the gap formed between the terminal 10 and the surface 311 of the pin 30 may present a smooth cosine wave-like shape change after three-dimensional expansion. A peak may represent the first portion 111 of the conductive element 11. A line segment region between the first portion 111 and the surface 311 may represent the gap between the first portion 111 and the surface 311. A trough may represent a starting point of contact between the conductive element 11 and the surface 311 (e.g., a line segment region between the surface 311 and the starting point of contact may represent the interference between the conductive element 11 and the pin 30). As shown by expanding the terminal 10 and the surface 311 of the pin 30 along the straight line, the gap formed between the terminal 10 and the surface 311 of the pin 30 may present a smooth cosine wave-like shape change. There is therefore an interference between the conductive element 11 and the pin 30.

A line segment region with a larger area may indicate a greater interference between the conductive element 11 and the pin 30 and therefore a larger pressing force to the conductive element 11 by the pin 30. A larger pressing force to the conductive element 11 by the pin 30 may lead to a larger abutting force against the inner wall of the sleeve 20 by the first portion 111.

The gap formed between the terminal 10 and the surface 311 of the pin 30 may be configured to have a smooth shape change (e.g., the smooth cosine wave-like shape change). The length of the line segments in the line segment region may therefore change gradually, as well as the structural deformation, the contact state with the pin 30, and the stress state of the conductive element 11, thereby enabling the structural reliability of the conductive element 11 and the efficient utilization of materials.

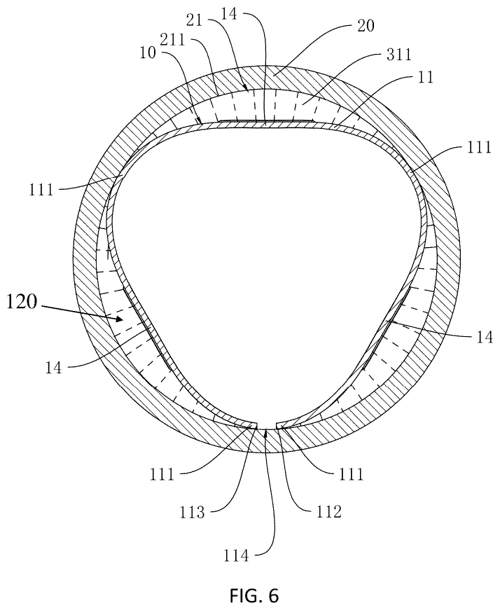

Referring to FIG. 6 and FIG. 8, FIG. 6 is a cross-sectional view of the electrical connector, showing a gap between the terminal 10 and an inner wall of the sleeve 20, and FIG. 8 is schematic diagram illustrating the gap between the terminal 10 and the inner wall of the sleeve 20, expanded to a straight line. As shown in the figures, the straight line may have a length equal to a circumferential perimeter of the inner wall (e.g., the wall 211) of the sleeve 20. As illustrated, the straight line is equally sectioned, corresponding to the line segments shown as dotted lines in FIG. 3. The line segments of the straight line and the line segments of a curve the inner wall (e.g., the wall 211) of the sleeve 20 may have the same lengths.

Taking the terminal 10 provided with three first portions 111 as an example, after expanding the terminal 10 and the inner wall of the sleeve 20 (e.g., the wall 211 of the cavity 21) along the straight line, the gap formed between the terminal 10 and the wall 211 may present a smooth cosine wave-like shape change. A peak may be a point on an outer side surface of a contact point between the conductive element 11 and the surface 311. A line segment region between this point and the wall 211 may represent an interference between the conductive element 11 and the wall 211. A trough may represent a starting point of contact between the first portion 111 and the wall 211. As shown by expanding the terminal 10 and the wall 211 along the straight line, the gap formed between the terminal 10 and the wall 211 may present a smooth cosine wave-like shape change after three-dimensional expansion. There is therefore an interference between the conductive element 11 and the wall 211.

A line segment region with a larger area may indicate a greater interference between the conductive element 11 and the wall 211 and therefore a larger abutting force to the wall 211 by the conductive element 11, thereby a stable connection.

The gap formed between the terminal 10 and the wall 211 may be configured to have a smooth shape change (e.g., the smooth cosine wave-like shape change). The length of the line segments in the line segment region may therefore change gradually, as well as the structural deformation, the contact state with the wall 211, and the stress state of the conductive element 11, thereby enabling the structural reliability of the conductive element 11 and the efficient utilization of materials.

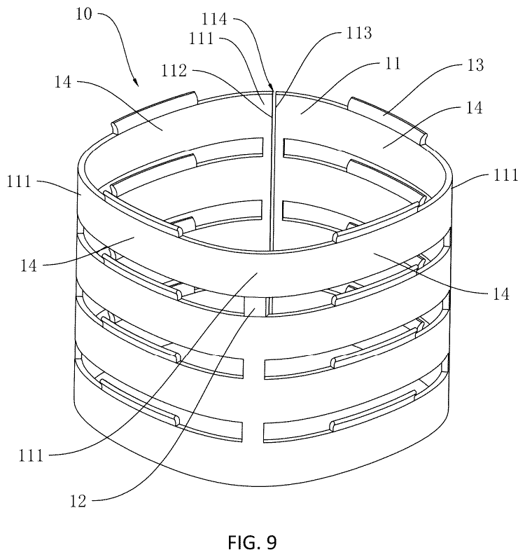

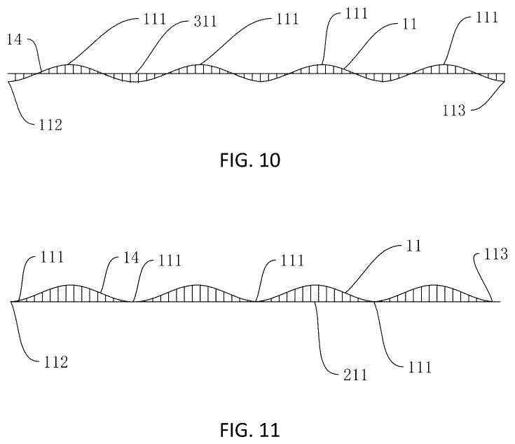

FIG. 9 to FIG. 11 show an embodiment having a conductive element 11 provided with four first portions 111. Assuming a diameter of the pin 30 is unchanged, the length of the pin is unchanged after being expanded along the straight line. As there are four peaks representing the first portions 111 of the conductive element 11, the area of the line segment region between each of the first portions 111 and the surface 311, which represents the gap between each of the first portions 111 and the surface 311, becomes smaller. As a result, the interference between the conductive element 11 and the pin 30, and thus the pressing force to the conductive element 11 by the pin 30, become smaller. Furthermore, the smaller the pressing force to the conductive element 11 by the pin 30, the smaller the abutting force against the inner wall of the sleeve 20 by the first portion 111. Similarly, the length of the line segments in the line segment region also presents the cosine wave-like shape change, so that the structural deformation, the contact state with the wall 211 and the stress state of the conductive element 11 can all keep the conductive element in a cosine-like gradual change state, thus ensuring the structural reliability of the conductive element 11 and the efficient utilization of materials. The same also applies when a plurality of first portions 111 are provided.

When the conductive element 11 is provided with more first portions 111 such that the abutting force of the first portion 111 is reduced, there is still interference between the conductive element 11 and the surface 311, and therefore the terminal 10 still has the connection stability. It should also be appreciated that, with an increasing number of the first portions 111, there are more contact points between the conductive element 11 and the sleeve 20, thereby a larger current overload capacity.

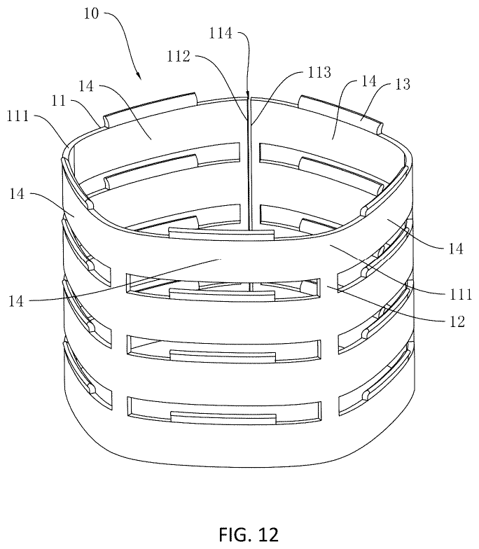

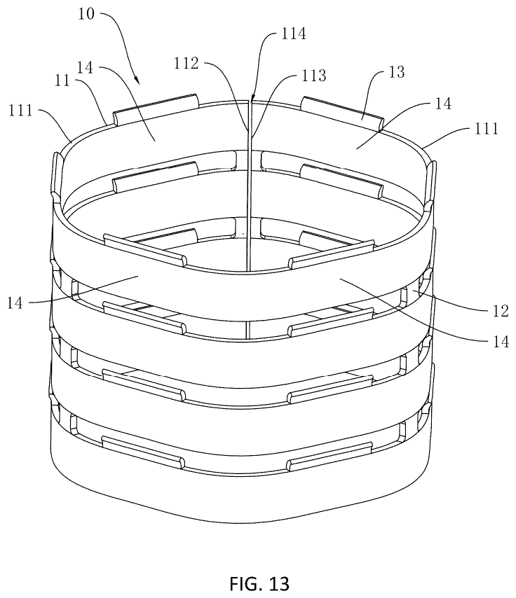

FIG. 12 and FIG. 13 show embodiments having the conductive element 11 provided with five and six first portions 111, respectively. The position of the opening 114 may not be limited. The opening 114 may be arranged in the first portion 111 or arranged between adjacent first portions 111.

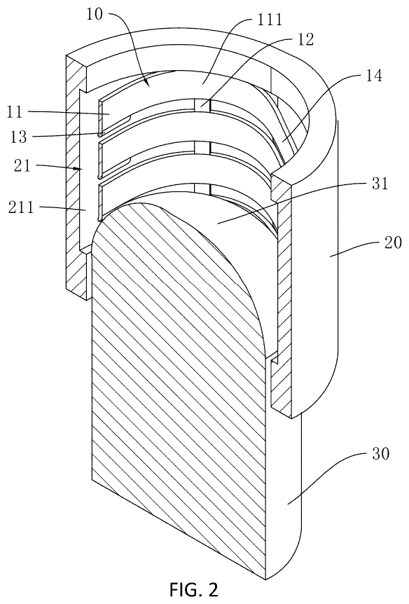

With reference to FIG. 3 and FIG. 2, in some embodiments of the present disclosure, two adjacent conductive elements 11 may be connected through a member 12. The member 12 may be integrated with the conductive element 11 by welding, or by buckling which be easy for disassemble or connection. In this way, according to a specific connection requirement, a rated number of conductive elements 11 can be provided, which may be sequentially connected through the member 12.

The member 12 may be located on one side of the first portion 111. For example, the member 12 may be arranged on an upper side or a lower side of the first portion 111, (e.g., in the axial direction 102 of the terminal 10). The member 12 may be used for connecting the first portions 111 of two adjacent conductive elements 11. Alternatively or additionally, the members 12 may be arranged on two sides of the first portion, which may increase a contact area between the first portion 111 and the wall 211 and therefore further increase a current overload capacity while enhancing the connection strength of the conductive element 11.

The conductive element 11 may comprise a plurality of second portions 14. The number of the second portions 14 may be determined according to the number of the first portions 111. Two ends of the second portion 14 may be respectively connected with ends of two adjacent first portions 111 so as to connect the first portions 111 in series.

The member 12 may be arranged between adjacent first portions 111 (e.g., on one side of the second portion 14). The member 12 may also be arranged in other positions, such as one side of a joint between the second portion 14 and the first portion 111. The conductive elements 11 may be overlapped in the axial direction 102 to increase a length of the terminal, thereby enabling producing terminals with different lengths.

With reference to FIG. 1 to FIG. 4, in some embodiments of the present disclosure, one side of the conductive element 11 may be provided with a projection 13. The projection 13 may be located between two adjacent first portions 111. One end of the projection 13 may be arranged on one side of the conductive element 11 and located between two adjacent first portions 111. When inserting the pin 30 into the terminal 10, the surface 311 may be first in contact with the projection 13 to stretch the conductive element 11. Such a configuration may prevent a surface of the pin 30 from being scratched by an edge of the conductive element 11. The projection 13 located between two adjacent first portions 111 may facilitate stretching a side surface of the conductive element 11 in contact with the pin 30, increasing a contact area between the two first portions.

According to aspects of the present disclosure, the length of a terminal 10 of an electrical connector may be adapted according to a pin 30. The number of first portions 111 of a terminal 10 of the electrical connector may be configured to provide a stable connection capability (e.g., under an elastic effect of the terminal 10). The number of connected conductive elements 11 may be configured to enable a controllable removing and inserting force, facilitating the inserting and removing of the pin 30 to and from the electrical connector, providing a comfortable use experience. Techniques describe herein may also enable the small and simple structure of the terminal 10 such that the electrical connector is low in manufacturing cost and more beneficial for product production.

With reference to FIG. 1 to FIG. 2, in some embodiments of the present disclosure, an inserting end of the pin 30 may be provided with an end surface 31. The end surface 31 may be shaped (e.g., curved) such that the end surface 31 may be attachable to the projection 13 of the terminal 10. The arrangement of the end surface 31 may facilitate the inserting of the pin 30 and therefore the contact with the projection 13 in the terminal 10, thereby facilitating the attachment of the pin 30 to the projection 13 and the inner side surface of the conductive element 11.

With reference to FIG. 2, in some embodiments of the present disclosure, two ends of the terminal 10 in the axial direction 102 may respectively abut against two ends of the cavity 21, which may reduce the risk of the terminal 10 disengaging the sleeve 20.

Various aspects are described in this disclosure, which include, but are not limited to, the following aspects:

1. A terminal (e.g., terminal 10) comprising one or more conductive elements (e.g., conductive element 11) encircling, at least in part, an area with a center (e.g., center 104), each of the one or more conductive elements comprising: at least two first portions (e.g., first portion 111) each offset from the center by more than a first radius (e.g., first radius 106); and a plurality of second portions (e.g., second portion 14) connecting adjacent first portions of the at least two first portions and offset from the center by less than the first radius.

2. The terminal of aspect 1 or any other aspect, wherein each of the one or more conductive elements is configured to expand and contract in a radial direction with respect to the center of the area.

3. The terminal of aspect 1 or any other aspect, wherein the one or more conductive elements comprises two conductive elements stacked in an axial direction extending perpendicular to a radial direction with respect to the center of the area.

4. The terminal of aspect 3 or any other aspect, comprising a member connecting the two conductive elements.

5. The terminal of aspect 4 or any other aspect, wherein the member is disposed between the two conductive elements and joins first portions of the two conductive elements.

6. The terminal of aspect 1 or any other aspect, wherein each of the one or more conductive elements comprises a first end and second end separated from each other.

7. The terminal of aspect 6 or any other aspect, wherein, for each of the one or more conductive elements: the first end and second end are disposed in one of the at least two first portions.

8. The terminal of aspect 1 or any other aspect, wherein at least one conductive element of the one or more conductive elements comprises one or more projections extending from an edge of the at least one conductive element and disposed between respective adjacent first portions of the at least one conductive element; and the one or more projections is angled away from the center.

9. The terminal of aspect 1 or any other aspect, wherein each of the one or more conductive elements comprises three to six first portions.

10. The terminal of any one of aspects 1-9 or any other aspect, wherein the one or more conductive elements is stamped from a sheet of metal.

11. The terminal of aspect 10 or any other aspect, wherein a thickness of the sheet defines a radial extent of each of the one or more conductive elements.

12. The terminal of aspect 10 or any other aspect, wherein a surface of the sheet defines surfaces of the one or more conductive elements facing the area.

13. The terminal of any one of aspects 1-9 or any other aspect, wherein each of the plurality of second portions comprises an elongated band.

14. The terminal of aspect 13 or any other aspect, wherein the elongated bands of the one or more conductive elements are disposed in parallel.

15. The terminal of aspect 13 or any other aspect, wherein each of at least two first portions comprises a bend.

16. An electrical connector comprising a sleeve (e.g., sleeve 20) comprising an inner wall (e.g., wall 211) bounding a cavity (e.g., cavity 21); and terminal disposed in the cavity and comprising a conductive element, the conductive element comprising first portions abutting the inner wall of the sleeve; and second portions disposed within the cavity and connecting adjacent first portions.

17. The electrical connector of aspect 16 or any other aspect, wherein each of the first portions comprises an inflection point abutting the inner wall of the sleeve.

18. The electrical connector of aspect 17 or any other aspect, comprising a plurality of gaps between portions of the terminal and the inner wall of the sleeve and separated from each other by the inflection points of respective first portions of the terminal abutting the inner wall of the sleeve.

19. The electrical connector of aspect 18 or any other aspect, wherein each of the plurality of gaps decreases toward the points of the respective first portions.

20. The electrical connector of aspect 19 or any other aspect, wherein each of the plurality of gaps is symmetrical.

21. The electrical connector of aspect 20 or any other aspect, wherein the plurality of gaps conforms to a wave.

22. The electrical connector of aspect 16 or any other aspect, wherein the conductive element comprises a first end and second end separate from the first end; and the first end and second end are disposed in a first portion.

23. The electrical connector of aspect 16 or any other aspect, wherein the terminal comprises a plurality of conductive elements comprising the conductive element; and the plurality of conductive elements are stacked in an axial direction extending through the cavity of the sleeve.

24. The electrical connector of aspect 23 or any other aspect, comprising a plurality of members joining first portions of adjacent conductive elements of the plurality of conductive elements.

25. The electrical connector of aspect 24 or any other aspect, comprising a plurality of projections extending from edges of the second portions of the plurality of conductive elements and angled away from a center of the cavity.

26. A terminal mated to a pin, the terminal comprising one or more conductive elements encircling, at least in part, the pin, each of the one or more conductive elements comprising at least two first portions and a plurality of second portions, wherein the plurality of second portions each contacts a surface of the pin at a first radius from a center of the pin; and the at least two first portions connect adjacent second portions of the plurality of second portions and offset from the center of the pin by more than the first radius.

27. The terminal of aspect 26 or any other aspect, wherein the one or more conductive elements is stamped from a sheet of metal.

28. The terminal of aspect 27 or any other aspect, wherein a thickness of the sheet defines a radial extent of each of the one or more conductive elements.

29. The terminal of aspect 27 or any other aspect, wherein a surface of the sheet defines surfaces of the one or more conductive elements facing the center.

30. The terminal of any one of aspect 26-29 or any other aspect, wherein each of the plurality of second portions comprises an elongated band.

31. The terminal of aspect 30 or any other aspect, wherein the elongated bands of the one or more conductive elements are disposed in parallel.

32. The terminal of aspect 30 or any other aspect, wherein each of at least two first portions comprises a bend.

33. The terminal of aspect 26 or any other aspect, wherein each of the one or more conductive elements comprises one or more projections extending from edges of the second portions of the conductive element.

34. A method of operating an electrical connector, the electrical connector comprising a sleeve having a cavity and a terminal disposed in the cavity and, the method comprising inserting a pin into the terminal; expanding the terminal; and generating pressure against a circumferential surface of the pin.

35. The method of aspect 34 or any other aspect, comprising generating pressure against an inner wall of the sleeve.

36. The method of aspect 34 or any other aspect, wherein the terminal comprises one or more conductive elements encircling, at least in part, an area with a center; and each of the one or more conductive elements comprises at least two first portions each offset from the center by more than a first radius, and a plurality of second portions connecting adjacent first portions of the at least two first portions and offset from the center by less than the first radius.

37. The method of aspect 36 or any other aspect, wherein expanding the terminal comprises expanding the at least two first portions such that contact areas between the at least two first portions and an inner wall of the sleeve increase; and expanding the plurality of second portions such that the plurality of second portions conform to the circumferential surface of the pin.

38. The method of aspect 36 or any other aspect, wherein each of the one or more conductive elements comprises a first end disposed in a first portion of the at least two first portions, and a second end disposed in the first portion of the at least two first portions and separated from the first end; and expanding the terminal comprises further increasing a distance between the first and second ends.

39. The method of aspect 36 or any other aspect, wherein each of the one or more conductive elements comprises a plurality of projections extending from edges of the plurality of second portions of the conductive element and angled away from the center; and expanding the terminal comprises for each of the one or more conductive elements, contacting the plurality of projections with the pin so as to guide the pin into contact with the plurality of second portions of the conductive element.

40. A wave spring (e.g., terminal 10), comprising a plurality of spring leaves (e.g., conductive element 11), wherein the spring leaves are annularly arranged, the spring leaves are sequentially connected and stacked in an axial direction, each of the spring leaves is provided with at least three abutting portions (e.g., first portion 111), the abutting portions are distributed around an outer side of a respective spring leaf, and the abutting portions are configured to expand and contract in a radial direction of the respective spring leaf.

41. The wave spring of aspect 40 or any other aspect, wherein each of the spring leaves is provided with a first end and a second end, the first end and the second end are configured to abut against each other and to define an opening (e.g., opening 114) cooperatively.

42. The wave spring of aspect 41 or any other aspect, wherein the opening is disposed in one of the at least three abutting portions.

43. The wave spring of aspect 40 or any other aspect, wherein adjacent spring leaves of the plurality of spring leaves are connected through a connecting sheet (e.g., member 12).

44. The wave spring of aspect 43 or any other aspect, wherein each of the plurality of spring leaves further comprises a plurality of connecting portions (e.g., second portion 14), two ends of each of the connecting portions are respectively connected with adjacent abutting portions of the at least three abutting portions, the connecting sheet is located on one side of a respective abutting portion or one side of the respective connecting portion, and the connecting sheet is configured for connecting the abutting portions of two adjacent spring leaves.

45. The wave spring of aspect 40 or any other aspect, wherein one side of each of the plurality of spring leaves is further provided with a guide portion (e.g., projection 13), and the guide portion is located between adjacent abutting portions of the at least three abutting portions.

46. The wave spring of aspect 40 or any other aspect, wherein the at least three abutting portions comprises three to six abutting portions.

47. A plug terminal connector, comprising the wave spring of any one of aspects 39 to 45 or any other aspect, wherein the plug terminal connector further comprises a sleeve, wherein an annular accommodating cavity is arranged in the sleeve, the wave spring is arranged in the accommodating cavity, and the abutting portions abut against a cavity wall (e.g., wall 211) of the accommodating cavity (e.g., cavity 21); and a contact pin, wherein the contact pin is pluggable into the wave spring.

48. The plug terminal connector of aspect 47 or any other aspect, wherein a plugging end of the contact pin is provided with an arc surface, and the arc surface is attachable to a guide portion of the wave spring.

49. The plug terminal connector of aspect 47 or any other aspect, wherein two ends of the wave spring in the axial direction respectively abut against two ends of the accommodating cavity.

50. A terminal comprising one or more conductive elements, each of the one or more conductive elements comprising a plurality of first portions each having an outermost point (e.g., point 122) disposed on a first annular shape (e.g., a circumference of the wall 211 of the sleeve 20 as shown in FIG. 4); and a plurality of second portions (e.g., points 124) disposed between adjacent first portions of the plurality of first portions and having end points joining respective first portions, the end portions of the plurality of second portions are disposed on a second annular shape (e.g., a circumference of the surface 311 of the pin 30 as shown in FIG. 4).

51. The terminal of aspect 50 or any other aspect, wherein the first annular shape and second annular shape are concentric.

52. The terminal of aspect 50 or any other aspect, wherein portions of each of the one or more conductive elements between adjacent outermost points of the plurality of first portions each is separated from the first annular shape by a gap (e.g., gap 120); and the gap decreases toward respective outermost points.

53. The terminal of aspect 52 or any other aspect, wherein the gap is symmetrical.

54. The terminal of aspect 50 or any other aspect, wherein each of the plurality of first portions is separated from the second annular shape by a first gap (e.g., gap 116); and each of the plurality of second portions is separated from the second annular shape by a second gap (e.g., gap 118) different from the first gap.

55. The terminal of aspect 50 or any other aspect, wherein each of the one or more conductive elements comprises a first end disposed in a first portion; and a second end disposed in the first portion and separated from the first end.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure.

Embodiments of the present disclosure are described in detail herein, examples of the embodiments are shown in the drawings, and the same or similar reference numerals throughout the drawings may denote the same or similar elements or elements having the same or similar functions. The embodiments described herein with reference to the drawings are exemplary, and are only intended to explain the present disclosure, but should not be understood as limiting the present disclosure.

In the description of the present disclosure, it should be understood that, the orientation or position relationship related to the orientation description, such as the orientation or position relationship indicated by the terms “upper”, “lower”, “front”, “rear”, “left”, “right”, and the like is based on the orientation or position relationship shown in the drawings, which is only used for convenience of the description of the present disclosure and simplification of the description instead of indicating or implying that the indicated device or element must have a specific orientation, and be constructed and operated in a specific orientation, and thus should not be understood as a limitation to the present disclosure.

In the description of the present disclosure, unless otherwise explicitly defined, the terms “setting”, “mounting” and “connecting” should be understood in a broad sense, and those of ordinary skills in the art can reasonably determine the specific meanings of the above terms in the present disclosure in combination with the specific contents of the technical solution.

What is claimed is:

1. A terminal comprising:
one or more conductive elements encircling, at least in part, an area with a center, each of the one or more conductive elements comprising:
at least two first portions each offset from the center by more than a first radius; and
a plurality of second portions connecting adjacent first portions of the at least two first portions and offset from the center by less than the first radius.

2. The terminal of claim 1, wherein:
each of the one or more conductive elements is configured to expand and contract in a radial direction with respect to the center of the area.

3. The terminal of claim 1, wherein:
the one or more conductive elements comprises two conductive elements stacked in an axial direction extending perpendicular to a radial direction with respect to the center of the area.

4. The terminal of claim 1, wherein:
each of the one or more conductive elements comprises a first end and second end separated from each other.

5. The terminal of claim 1, wherein:
at least one conductive element of the one or more conductive elements comprises one or more projections extending from an edge of the at least one conductive element and disposed between respective adjacent first portions of the at least one conductive element; and
the one or more projections is angled away from the center.

6. The terminal of claim 1, wherein:
each of the one or more conductive elements comprises three to six first portions.

7. The terminal of claim 1, wherein:
the one or more conductive elements is stamped from a sheet of metal;
a thickness of the sheet defines a radial extent of each of the one or more conductive elements; and
a surface of the sheet defines surfaces of the one or more conductive elements facing the area.

8. An electrical connector comprising:
a sleeve comprising an inner wall bounding a cavity; and
a terminal disposed in the cavity and comprising a conductive element, the conductive element comprising:
first portions abutting the inner wall of the sleeve; and
second portions disposed within the cavity and connecting adjacent first portions.

9. The electrical connector of claim 8, wherein:
each of the first portions comprises an inflection point abutting the inner wall of the sleeve; and
the electrical connector comprises a plurality of gaps between portions of the terminal and the inner wall of the sleeve and separated from each other by the inflection points of respective first portions of the terminal abutting the inner wall of the sleeve.

10. The electrical connector of claim 9, wherein:
each of the plurality of gaps decreases toward the inflection points of the respective first portions.

11. The electrical connector of claim 8, wherein:
the terminal comprises a plurality of conductive elements comprising the conductive element; and
the plurality of conductive elements are stacked in an axial direction extending through the cavity of the sleeve.

12. The electrical connector of claim 11, comprising:
a plurality of members joining first portions of adjacent conductive elements of the plurality of conductive elements.

13. The electrical connector of claim 11, comprising:
a plurality of projections extending from edges of the second portions of the plurality of conductive elements and angled away from a center of the cavity.

14. A terminal mated to a pin, the terminal comprising:
one or more conductive elements encircling, at least in part, the pin, each of the one or more conductive elements comprising:
at least two first portions and a plurality of second portions, wherein:
the plurality of second portions each contacts a surface of the pin at a first radius from a center of the pin; and
the at least two first portions connect adjacent second portions of the plurality of second portions and offset from the center of the pin by more than the first radius.

15. The terminal of claim 14, wherein:
each of the plurality of second portions comprises an elongated band; and
the elongated bands of the one or more conductive elements are disposed in parallel.

16. The terminal of claim 15, wherein:
each of at least two first portions comprises a bend.

17. A wave spring, comprising:
a plurality of spring leaves, wherein:
the plurality of spring leaves are annularly arranged, the plurality of spring leaves are sequentially connected and stacked in an axial direction;
each of the plurality of spring leaves is provided with at least three abutting portions;
the at least three abutting portions are distributed around an outer side of a respective spring leaf; and
the at least three abutting portions are configured to expand and contract in a radial direction of the respective spring leaf.

18. The wave spring of claim 17, wherein:
each of the plurality of spring leaves is provided with a first end and a second end;
the first end and the second end are configured to abut against each other and to define an opening cooperatively; and
the opening is disposed in one of the at least three abutting portions.

19. The wave spring of claim 17, wherein:
adjacent spring leaves of the plurality of spring leaves are connected through a connecting sheet.

20. The wave spring of claim 19, wherein:
each of the plurality of spring leaves further comprises a plurality of connecting portions;
two ends of each of the plurality of the connecting portions are respectively connected with adjacent abutting portions of the at least three abutting portions;
the connecting sheet is located on one side of a respective abutting portion or one side of a respective connecting portion; and
the connecting sheet is configured for connecting abutting portions of two adjacent spring leaves.

21. The wave spring of claim 17, wherein:
one side of each of the plurality of spring leaves is further provided with a guide portion; and
the guide portion is located between adjacent abutting portions of the at least three abutting portions.
